(19) United States
(12) Patent Application Publication
(10) Pub. No.: US 2023/0346132 A1
(43) Pub. Date: Nov. 2, 2023

(54) Remote Controlled Firmness Adjustable and Massager Mattress

(71) Applicant: ilham oz, Pennsauken, NJ (US)

(72) Inventor: ilham oz, Pennsauken, NJ (US)

(21) Appl. No.: 18/349,131

(22) Filed: Jul. 8, 2023

(51) Int. Cl. A47C 27/18; A61H 9/00

(52) U.S. Cl. CPC A47C 27/18; A61H 9/0078; A61H 2201/0146

(57) ABSTRACT

This mattress consists of 2 (two) layers of foam; bottom and top layers. The bottom layer is a firm foam that consists of cylindrical holes through the width of the mattress. In these holes, there are rubber cylindrical airbags that can be inflated or deflated at different levels by the user's remote control via an air pump embedded inside the mattress. The top layer is a softer foam that consists of hemispherical holes embedded on the surface of the layer. In these holes, there are massager elements that can be controlled by the same remote control. With this remote control, the user can not only adjust the level of firmness-softness and also massage her-his body and/or body parts at customized intensity levels. Moreover, for double mattresses, there will be 2 different remote controls in order to be used separately for partners. The remote control can be wired or wireless.

### BACKGROUND

A mattress is a fabric case filled with a resilient material (such as cotton, hair, feathers, foam rubber, or an arrangement of coiled springs) used either alone as a bed or on a bedstead (definition ref—Merriam-webster.com). In today's Modern World, mattresses provide many functions for people like sleeping or resting or having sex, moreover also activities like working with computers, watching TV, reading books, having phone talk, making exercises, etc. on them.

### SUMMARY

Mattresses' being soft or hard has been always a purchase decision criterion, question mark, and dilemma for users. And also, partners might need and feel comfort according to their body types-sleeping habits at different firmness levels. Moreover, during many useful functions of mattresses, comfort levels come from different levels of firmness. For example, watching TV on a mattress might need a firmer level, on the other side reading a book on the mattress might need a softer level, etc., according to the anatomic and comfortable body needs of the user. On the other side, hard-working daily life forces the human body to have a massage to recover physically and mentally. This mattress solves this problem 1—by providing different levels of firmness and 2—also massaging according to different parts of the body.

### DESCRIPTION

The bottom layer with airbags embedded in, provides firmness levels with deflating-inflating air inside of them by remote control with levels via the help of an air pump embedded inside the mattress. These air pressure differences cause the mattress to be hard or soft or medium levels and their combinations are scaled from 1 to 10 on remote controls. The top layer which consists of massager elements embedded on the surface of the layer provides a massage function at different parts of the body at different intensity levels. So all turns out to be a mattress with both firmness adjustable and massager functions and also that can be used separately and customized by partners on the same mattress. So, double mattresses have 2 separate air pumps with 2 separate remote controls.

Items to be utilized-manufactured will be; an air pump embedded in the mattress that functions to inflate and deflate the airbags, embedded electrical wires from the air pump to the remote control (if wired), embedded massager elements, and their embedded wires from each element to the remote control, remote control main unit, foam layers with hole cuts according to airbags' and massager elements' placements and a mattress cover that covers this inner layers to form a finished and sellable product.

### DESCRIPTION OF THE DRAWINGS

FIG. 1 is the side view of the finished mattress with landscape orientation. Layer 1 is the top layer and consists of circular massager units 3, embedded in the hemispherical holes on top of layer 1. In light of this info, the top layer 1 can be called as “massager layer” of the mattress.

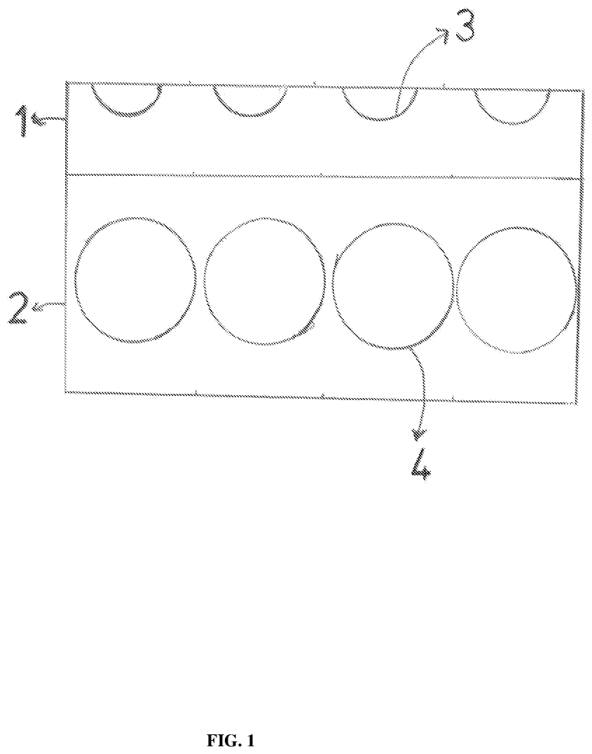

Bottom layer 2 consists of rubber cylindrical airbags 4 embedded in the holes of layer 2. These holes, likewise in layer 1, are cut to fit for the airbags to be embedded within layer 2. Layer 2 can be also called as the “firmness adjuster layer of the mattress”

FIG. 2 reflects the view of layer 1 from the top view with a portrait orientation. All massager units 3, were equally located to the equally distanced holes of the top layer, in order to cover all body parts and also customize the massage according to the body part to be massaged, chosen by the user via remote control.

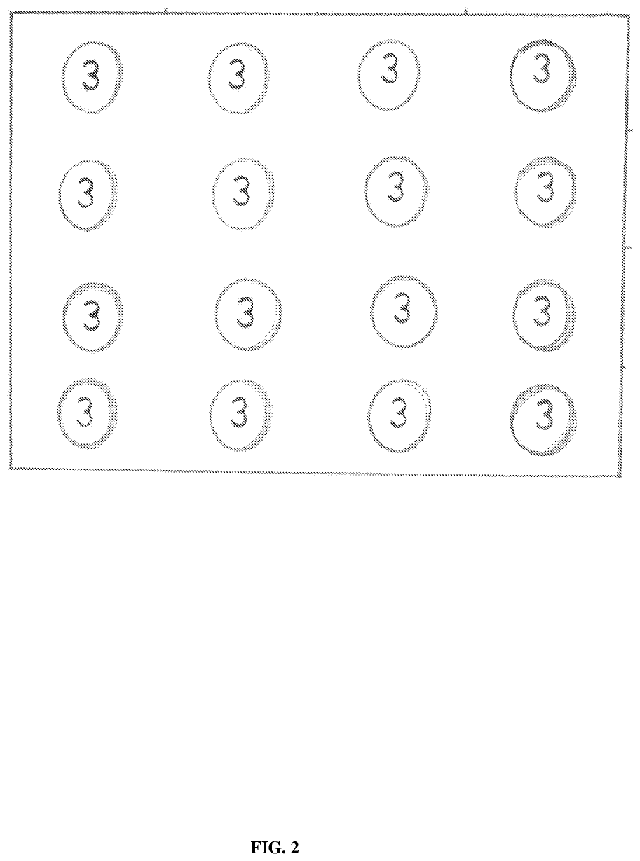

FIG. 3 shows the portrait orientation of bottom layer 2, airbags 4 are embedded in it. All these cylindrical airbags 4, are located to cover the major portion of the bottom layer, in order to give the sensitive feeling to the user for every one scale difference of firmness degreed from 1 to 10 on remote control.

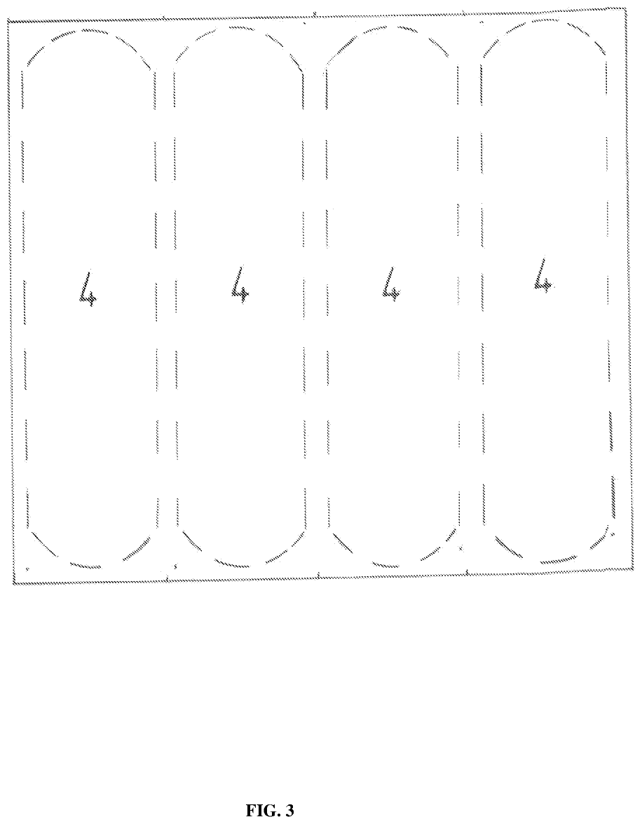

1. A mattress comprising:
Remote-controlled adjustable air pressure levels that lead to different firmness levels for the body

2. A mattress as in claim 1 further comprising:
Remote-controlled massager function that massages to different parts of the body

3. A mattress as in claim 1 further comprising:
The ability to have these functions work with all types of filling materials that constitute a mattress, not dependent to foam-type filling materials only
